(19) United States
(12) Patent Application Publication
(10) Pub. No.: US 2011/0064966 A1
(43) Pub. Date: Mar. 17, 2011

(54) LIPOSOMAL COMPOSITIONS AND METHODS FOR USE

(75) Inventors: Frank C. Scarpa, Jupiter, FL (US); Dennis Johnson, Fair Grove, MO (US)

(73) Assignee: Frank C. Scarpa, Jupiter, FL (US)

(21) Appl. No.: 12/953,021

(22) Filed: Nov. 23, 2010

Related U.S. Application Data
(63) Continuation of application No. 11/900,400, filed on Sep. 10, 2007, now abandoned.
Application No. 11/900,400 is a continuation of application No. PCT/US2006/008465, filed on Mar. 9, 2006.
(60) Provisional application No. 60/660,495, filed on Mar. 9, 2005.

(51) Int. Cl. B32B 5/16; C25D 15/00; B32B 15/00; B32B 15/02; B32B 15/04; B32B 1/08; B32B 3/00; B05D 1/18; B05D 3/02

(52) U.S. Cl. 428/614; 205/109; 428/323; 428/34.1; 428/172; 205/50; 427/430.1; 427/383.1; 420/591

(57) ABSTRACT

Disclosed herein are novel liposome compositions generally including a foreign inclusion (e.g., diamond) component, and a liposome (e.g., a paucilamellar liposome) component. Also disclosed are methods of using these composition for plating and plate obtained thereby. Novel liposomal compositions including components such as diamonds, are also disclosed, which can be used in a variety of applications, such as in abrasive, cosmetic or medical applications.

### RELATED APPLICATIONS

This application is related and claims priority to U.S. Provisional Application Ser. No. 60/660,495, filed Mar. 9, 2005. The entire contents of this application are incorporated herein by this reference.

### TECHNICAL FIELD

The present invention relates generally to compositions that include liposomes and a foreign inclusion (e.g., diamond) component, methods of using of these compositions (e.g., in metal plating and/or in polishing formulations), and compositions (e.g., plate) obtained by these methods.

### BACKGROUND OF THE INVENTION

Abrasive tools have been used in numerous applications, including cutting, drilling, sawing, grinding, lapping and polishing materials. Foreign inclusions, e.g., diamond inclusions, are employed as superabrasives on saws, drills, and other devices which utilize the abrasive to cut, shape or polish other hard materials, because of their properties, e.g., the high hardness and high thermal conductivity of diamond.

Diamond coated tools are useful for applications where other tools lack the hardness and durability to be practical substitutes, e.g., in the stone industry, where rocks are cut, drilled, and sawed. Moreover, in the precision grinding industry, diamond tools, due to their superior wear resistance, are capable of developing the tolerances required, while simultaneously withstanding wear.

Despite the prevailing use of diamond tools, the useful life of the tools is limited. For example, it has been estimated that in a typical diamond tool, less than about one tenth of the grit is actually consumed in the intended application, i.e., during actual cutting, drilling, polishing, etc. The remainder of the diamond grit is either wasted by being leftover when the tool's useful life has expired, or is wasted by being pulled-out or broken during use.

### SUMMARY OF THE INVENTION

A novel approach to compositions and methods for plating with foreign inclusions has now been discovered, thus providing plating with improved properties, e.g., improved hardness, wear resistance, impact resistance, coloration, lubricity, uniformity and/or thermal transfer of the plated surface. By practicing the disclosed inventions, the skilled practitioner can economically manufacture tools and/or other materials (e.g., building materials) with improved properties.

Accordingly, in one aspect, the present invention provides a paucilamellar foreign inclusion liposome composition which includes a liposome component and a foreign inclusion component. The liposome component can be disposed in a suspension, and the suspension can be a plating bath. In some embodiments, the composition is an abrasive, polish, plating bath, polymer additive, or medicament composition.

In some embodiments, the paucilamellar liposome is at least partially disposed within a metallic matrix. The metallic matrix can be, but is not limited to matrices which include boron nickel, chromium, nickel, copper, palladium, gold, silver, zinc, tin, cobalt, aluminum, and combinations thereof. In some embodiments, the metallic matrix is plating. In other embodiments, the plating can be disposed about a saw tool, a drill bit, a cutting tool, a grinding tool, an abrasive tool, a screw, a bolt, a nut, a pipe, a beam, an I-beam, and/or a metal cable.

In certain embodiments, the dispersion of the foreign inclusion particles in the metallic matrix is substantially uniform. In other embodiments, the liposome composition is stable at temperatures between about 140° F. and about 195° F. In still other embodiments, the liposome composition is stable at a pH of between about 4 and about 12.

In some embodiments, the composition can further include a zeta potential modifying agent, e.g., a peptide. Exemplary peptides include, but are not limited to heptalysine, acetyl heptalysine amide, acetyl heptalysine (acrylodan cysteine) amide, or analogs thereof.

In other embodiments, the liposome is at least partially disposed within a metallic matrix. The metallic matrix can be, but is not limited to boron nickel, chromium, nickel, copper, palladium, gold, silver, zinc, tin, cobalt, aluminum, and combinations thereof. In some embodiments, the composition is plating. The plating can be disposed about a saw tool, a drill bit, a cutting tool, a grinding tool, an abrasive tool, a screw, a bolt, a nut, a pipe, a beam, an I-beam, and/or a metal cable.

In some embodiments, the dispersion of the foreign inclusion particles in the metallic matrix is substantially uniform. In some embodiments, the composition is stable at temperatures between about 140° F. and about 195° F. In some embodiments, the composition is stable at a pH of between about 4 and about 12. In some embodiments, the composition also includes a zeta potential modifying agent, e.g., a peptide. The peptide can be, but is not limited to heptalysine, acetyl heptalysine amide, acetyl heptalysine (acrylodan cysteine) amide, or analogs thereof.

In still another aspect, the present invention is directed to composition including a plurality of foreign inclusion liposomes at least partially disposed within a metallic matrix. In some embodiments, the composition is plating. The plating can be disposed about a saw tool, a drill bit, a cutting tool, a grinding tool, an abrasive tool, a screw, a bolt, a nut, a pipe, a beam, an I-beam, and/or a metal cable.

In some embodiments, the metallic matrix can be, but is not limited to boron nickel, chromium, nickel, copper, palladium, gold, silver, zinc, tin, cobalt, aluminum, and combinations thereof. In some embodiments, the dispersion of the foreign inclusion particles in the metallic matrix is substantially uniform.

In yet another aspect, the present invention includes a composition including a plurality of foreign inclusion particles at least partially disposed within a metallic matrix, wherein the dispersion of the foreign inclusion particles in the metallic matrix is substantially uniform. In some embodiments, the level of homogenization of foreign inclusion particles in the metallic matrix is between about 100 counts/μm³ and about 10,000 counts/μm³. In other embodiments, the hardness of the compositions is above about 2500 knoop.

In some embodiments, the metallic matrix includes, but is not limited to, boron nickel, chromium, nickel, copper, palladium, gold, silver, zinc, tin, cobalt, aluminum, and combinations thereof. In some embodiments, the composition is plating. The plating can be disposed about a saw tool, a drill bit, a cutting tool, a grinding tool, an abrasive tool, a screw, a bolt, a nut, a pipe, a beam, an I-beam, and/or a metal cable.

In some aspects, the present invention is directed to a plated article of manufacture for industrial processes or for building processes. The plated article includes an article of manufacture and any of the compositions described herein. The article of manufacture can be, for example a saw tool, a drill bit, a cutting tool, a grinding tool, an abrasive tool, a screw, a bolt, a nut, a pipe, a beam, an I-beam, and/or a metal cable.

In still another aspect, the present invention provides a method for plating. The method generally includes providing a plurality of foreign inclusion liposomes comprising a liposome component and a foreign inclusion component in a plating apparatus; and plating with a metal such that at least a portion of the foreign inclusion components are at least partially disposed in a metallic matrix. The plating apparatus can be an electroless plating bath or an electrolytic plating bath.

In some embodiments, the method also includes heat treating the plating. In some embodiments, the metallic matrix is plated in a substantially uniform thickness. In other embodiments, the dispersion of the foreign inclusion component in the metallic matrix is substantially uniform. In some embodiments, the plating apparatus is a bath comprising a suspension of foreign inclusion liposomes.

The foreign inclusion component can be, but is not limited to all of the foreign inclusions listed herein. For example, foreign inclusions include diamond, diamond-like carbon, boron nitride, boron carbide, aluminum oxide, silicon carbide, tungsten carbide, titanium carbide, alumina, sapphire, zirconia, colorant, and mixtures thereof. In some embodiments, the foreign inclusion component includes diamond or diamond-like carbon. The diamond can be synthetic diamond. Alternatively, the diamond can be, but is not limited to, ultra disperse diamond, polycrystalline diamond, saw grit diamond, powdered diamond, monocrystalline diamond, and mixtures thereof. In one embodiment, the diamond or diamond-like carbon is dispersed about a metallic sphere. In yet another embodiment, the diamond includes monocrystalline diamond. In some embodiments, the foreign inclusion component includes a colorant, e.g., an insoluble dye or pigment. In some embodiments, the colorant is titanium dioxide. In some embodiments, the foreign inclusion component comprises foreign inclusion particles having a mean diameter of less than about 1 micron. In other embodiments, the diameter is between about 2 nm and about 200 nm.

The metallic matrix can be, but is not limited to boron nickel, chromium, nickel, copper, palladium, gold, silver, zinc, tin, cobalt, aluminum, and combinations thereof. Furthermore, the plating can be disposed about a saw tool, a drill bit, a cutting tool, a grinding tool, an abrasive tool, a screw, a bolt, a nut, a pipe, a beam, an I-beam, and/or a metal cable.

In some embodiments, the composition is stable at temperatures between about 140° F. and about 195° F. In some embodiments, the composition is stable at a pH of between about 4 and about 12.

In some embodiments, the method is repeated one or more times. In further embodiments, the size, type, quality, or concentration, of foreign inclusion components is varied during the one or more times the method is repeated.

In still other aspects, the present invention is directed to a composition which includes a metallic matrix, a foreign inclusion, and a lubricant, wherein the lubricant comprises lipid. The lipid can be one or more liposomes. Additionally, the lubricant can further include PTFE.

### BRIEF DESCRIPTION OF THE DRAWINGS

FIG. 1 is an image of an exemplary electroplated diamond surface using paucilamellar diamond liposomes of the present invention in the electroplating process. At higher magnification, small circles are evident, which are diamonds. This image was captured on a 400× microscope and digitally magnified to about 800×.

FIG. 2 is an S.E.M. image of exemplary electroless nickel plated diamond surface using paucilamellar diamond liposomes of the present invention in the electroless nickel plating process.

### DETAILED DESCRIPTION OF THE INVENTION

The present invention provides novel compositions, such as paucilamellar liposomal compositions, that can be employed, e.g., in the manufacture of a plate and/or in a polishing formulation. The present invention further provides novel compositions manufactured by employing the novel liposomal compositions. Also provided are methods of manufacture of the liposomal compositions and the plate. The invention is based, at least in part, on the discovery that liposomal compositions can be employed to manufacture plate. One advantage of such compositions is that the dispersion of foreign inclusion bodies (e.g., diamonds) in the plate can be improved, thereby improving properties of the plate, such as hardness. The present invention is also based, at least in part, on the discovery that liposomal compositions which include a foreign inclusion are stable, e.g., do not aggregate, for an extended period of time. One advantage of such compositions is the extended shelf life with little or no need for mixing. That is, the solution can be maintained in a plating bath or a polishing formulation for an extended period of time with no need for mixing.

In one aspect, the present invention provides a foreign inclusion liposome composition. The composition generally includes a liposome component and a foreign inclusion component. In certain embodiments, the liposome component and the foreign inclusion component can be any of the liposomes or foreign inclusions described herein, any liposomes or foreign inclusions known to a person of ordinary skill in the art, and/or any combinations thereof. The liposomes of the present invention can be unilamellar, paucilamellar, or multilamellar. If unilamellar, the liposomes can be small unilamellar vesicles (SUVs) or large unilamellar vesicles (LUVs). In certain embodiments, the liposomes are paucilamellar liposomes. Paucilamellar liposomes can be advantageous, e.g., because they provide a central cavity which is substantially sized while maintaining more than one lipid bilayer, e.g., to protect or retain the contents of the cavity.

The compositions of the present invention can be in solution or suspension. The solution or suspension can be aqueous or organic. A solution or suspension can be advantageous for, e.g., a plating bath. Alternatively, compositions can be dried or lyophilized to form a powder. A dried or lyophilized composition can be more suitable for storage or shipping than a solution or suspension.

The liposome component can be fully or partially disposed about the foreign inclusion. Such a composition can be advantageous, e.g., in processes where foreign inclusions otherwise tend to aggregate and/or settle. In some embodiments, some or all of the liposome component can not be disposed about a foreign inclusion, i.e., the liposomes can be disposed about an aqueous or nonaqueous cavity. That is, the present invention includes liposomes with one or more foreign inclusions as or within their central cavity, liposomes with foreign inclusions contained within an aqueous or nonaqueous central cavity, and/or liposomes with an aqueous or nonaqueous cavity, where the foreign inclusion is elsewhere included in the composition. For example, in some embodiments the foreign inclusion component is not disposed within the liposomes, in such embodiments, the liposome can serve to increase the dispersion of the foreign inclusion component because of its ability to reduce surface tension and/or increase the buoyancy of the inclusion particles within the composition.

In certain embodiments and aspects, the invention pertains to the use of foreign inclusion liposomes in plating processes. Accordingly, in some embodiments, the foreign inclusion liposomes are used in an aqueous or nonaqueous suspension or solution as a plating bath. These compositions can be used in plating processes (e.g., electrolytic or electroless plating processes) to introduce a foreign inclusion into a metallic matrix. One advantage of such plating compositions is that they allow for great uniformity in the dispersion of foreign inclusions within the metallic matrix, which in turn can lead to greater strength and wear resistance of the plate.

Additionally or alternatively, in some embodiments, the novel liposomal compositions described herein can be used as, or included in, other processes or compositions, e.g., an abrasive, a polish, a polymer additive, a skin cleanser, a dewatering composition, a drug delivery composition, red blood cell surrogates for carrying oxygen, and in a medicament composition. That is, in some embodiments, the invention provides novel liposomal compositions (e.g., including diamonds) which can be used in a variety of indications or purposes, and is not limited to plate and plating methods.

Accordingly, in one embodiment, the foreign inclusions and/or foreign inclusion liposomes as described above are included in compositions for use as polishing formulations. That is, the present invention also relates to a stable polishing formulation. As used herein, the term “stable” polishing formulation refers generally to a formulation of the present invention where the foreign inclusion liposomes remain in a solution or suspension for a desired period of time. For example, the liposomes may remain in solution for at least about a week, at least about two weeks, at least about three weeks, at least about a month, at least about two months, at least about three months, at least about four months, at least about six months, at least about a year or more.

Additionally, in some embodiments, the size of the foreign inclusion particle that can be made available in a polishing formulation of the present invention is advantageous, e.g., in electronics, fiberoptics (e.g., in order to polish a cross section) and optics (e.g., in order to polish lenses). For such uses, a very small diameter particle (e.g., 20-30 nm) is generally desired. However, foreign inclusion particles, e.g., diamonds, aggregate readily at this size. Currently, diamond particles in polishing formulations range from about 150 nm to about 1 μm, due at least in part to such aggregation. Without wishing to be bound by any particular theory, it is believed that the foreign inclusion liposomes of the present invention can include a few (e.g., about 2-3) small foreign inclusion particles in each liposome. Accordingly, in one embodiment, the liposomes of the present invention include a plurality of foreign inclusions, providing a uniform composition that substantially resists aggregation. Additionally or alternatively, the foreign inclusion liposome composition can maintain a relatively constant concentration gradient of small foreign inclusion particles and is suitable for use not only as a solid or a paste, but also in the form of a spray or aerosol. One advantage of such a composition is that the concentration of liposomes applied, e.g., by spraying, is substantially uniformly applied over time.

Accordingly, also provided herein is a method for polishing a surface, e.g., a hard surface, with a composition of the present invention. Without wishing to be bound by any particular theory, it is believed that the liposome will be disrupted during polishing, thus allowing the foreign inclusion to be at least partially in contact with the surface, thus allowing effective polishing. The compositions of the present invention may be used alone to polish a surface. Additionally or alternatively, the compositions of the present invention can be used with another composition or device, e.g., a polishing tool, to polish a surface. The polishing formulation can be in the form of a solution, suspension, emulsion, paste or solid. If the formulation is in the form of a solid or a paste, it may or may not be added to a liquid (e.g., water) prior to use.

Polishing formulations of the present invention can be used on hard surfaces such as metal plating, metal, stainless steel, stone, resin type surfaces such as FORMICA, ceramics and vitreous enamel such as porcelain, aluminum, and the like to provide effective cleaning. In some embodiments, the function of an abrasive substance in polishing formulations intended for use on hard surfaces is to remove various deposits and stains from the surface thereof and to generally clean them without unduly scratching said surfaces. In some embodiments, polishing formulations maximize soil and stain removal without causing undue abrasion (e.g., scratching) to said hard surface.

In some embodiments, the foreign inclusion includes a typical abrasive, e.g., diamonds, finely divided silica, feldspar, pumice, kieselguhr, labradorite, calcite, emery and carborundum. For example, diamond grit is a very effective polishing medium, able to polish stones and other objects that can not be polished with other polishing formulations.

In some embodiments, the polishing formulation contains at least one surface-active agent, e.g., to achieve increased detergency action. The organic surface-active material may be anionic and/or nonionic, in nature. The organic surface-active material may employ as the surface-active agent a detersive material which imparts to the composition detersive and foaming properties. In some embodiments, the total amount of surfactant is about 2-15% by weight of the cleanser. In some embodiments, the total amount of surfactant is about 5-10% by weight of the cleanser.

The size of the liposomes of the present invention can vary. Generally, the size of the liposome will depend upon the size of the contents of the internal cavity, e.g., the foreign inclusion. The liposomes of the present invention can generally have a mean diameter of less than about 1 micron. For example, the mean diameter can be less than about 900 nm, 800 nm, 700 nm, 600 nm, 500 nm . . . 1 nm. Alternatively, the mean diameter of the liposome can be greater than about 1 μm, 2 μm, 3 μm, 4 μm, 5 μm, . . . 10 μm.

As used herein, the term “liposome” refers generally to a lipid vesicle that is made of materials having high lipid content, e.g., surfactants or phospholipids. The lipids of these vesicles are generally organized in the form of lipid bilayers. The lipid bilayers generally encapsulate a volume which is either interspersed between multiple onion-like shells of lipid bilayers (forming multilamellar lipid vesicles or “MLV”) or contained within an amorphous central cavity. Lipid vesicles having an amorphous central cavity are unilamellar lipid vesicles, i.e., those with a single peripheral bilayer surrounding the cavity. Large unilamellar vesicles (“LUV”) generally have a diameter greater than about 1 μm while small unilamellar lipid vesicles (“SUV”) generally have a diameter of less than 0.2 μm. There are a variety of uses for lipid vesicles including the use as adjuvants or as carriers for a wide variety of materials.

Although generally the investigation of lipid vesicles has centered on multilamellar and the two types of unilamellar lipid vesicles, some investigation of a fourth type of lipid vesicle, the paucilamellar lipid vesicle (“PLV”), has also occurred. PLVs include about 2 to 8 peripheral bilayers surrounding a large, unstructured central cavity. In many of the previously described PLVs, this central cavity is filled with an aqueous solution. See Callo and McGrath, Cryobiology 1985, 22(3), pp. 251-267. Others present PLVs with organic and/or solid central cavities, as described, e.g., in U.S. Pat. No. 4,911,928.

Each type of lipid vesicle appears to have certain uses for which it is best adapted. For example, MLVs have a higher lipid content than any of the other lipid vesicles so to the extent that a lipid vesicle can encapsulate or carry a lipophilic material in the bilayers without degradation, MLVs have been deemed the most advantageous for carrying lipophilic materials. In contrast, the amount of water encapsulated in the aqueous shells between the lipid bilayers of the MLVs is much smaller than the water which can be encapsulated in the central cavity of LUVs, so LUVs have been considered advantageous in transport of aqueous material. However, LUVs, because of their single lipid bilayer structure, are not as physically durable as MLVs and are more subject to enzymatic degradation. SUVs have neither the lipid or aqueous volumes of the MLVs or LUVs but because of their small size have easiest access to cells in tissues.

PLVs appear to have advantages as transport vehicles for many uses, as compared with the other types of lipid vesicles. In particular, because of the large unstructured central cavity, PLVs are easily adaptable for transport of large quantities of aqueous-based materials. However, the multiple lipid bilayers of the PLVs provide them with the capacity to transport a greater amount of lipophilic material in their bilayers as well as with additional physical strength and resistance to degradation as compared with the single lipid bilayer of the LUVs.

PLVs can be made by modifications to processes of malcing MLVs. For example, the paucilamellar lipid vesicles can be made, e.g., as described in U.S. Pat. Nos. 4,853,228, 4,855,090, 4,911,928, and 5,147,723. In an exemplary method, a lipid and/or surfactant and foreign inclusions are combined to form a mixture. Suitable surfactants can be, but are not limited to, polyoxyethylene fatty esters, polyoxyethylene fatty acid ethers, diethanolamides, long chain acyl hexosamides, long chain acyl amino acid amides, long chain acyl amides, polyoxyethylene (20) sorbitan mono- or trioleate, polyoxyethylene glyceryl monostearate with 1-10 polyoxyethylene groups, glycerol monostearate, and combinations thereof. This mixture is then blended with an aqueous phase consisting of an aqueous buffer and any aqueous soluble materials to be encapsulated, under shear mixing conditions, to form the paucilamellar lipid vesicles. “Shear mixing” is defined as the mixing of the lipophilic phase with the aqueous phase under turbulent or shear conditions which provide adequate mixing to hydrate the lipid and form lipid vesicles. The pump speeds are modified depending on the viscosity of the materials and the size of the orifices selected. “Shear mixing” is achieved by liquid shear which is substantially equivalent to a relative flow rate for the combined phases of about 5-30 m/s through a 1 mm radius orifice.

The present invention relates, in some embodiments, to paucilamellar liposome compositions that include a liposome component and a foreign inclusion component. These lipid vesicles, which can be formed of phospholipids or non-phospholipid surfactant material, are characterized by 2-8 lipid bilayers optionally with a small aqueous volume separating each lipid shell. The lipid bilayers surround an amorphous central cavity filled with a foreign inclusion component. Alternatively, as described above, the central cavity can contain an aqueous or nonaqueous cavity which can or can not include one or more foreign inclusions.

In some embodiments, a charge producing amphiphile can be included to yield a net positive or negative charge to the lipid vesicles. Some negative charge producing materials include oleic acid, dicetyl phosphate, palmitic acid, cetyl sulphate, retinoic acid, phosphatidic acid, phosphatidyl serine, and mixtures thereof. In order to provide a net positive charge to the vesicles, long chain amines, e.g., stearyl amines or oleyl amines, long chain pyridinium compounds, e.g., cetyl pyridinium chloride, quaternary ammonium compounds, or mixtures of these can be used. An additional positive charge producing material is hexadecyl trimethylammonium bromide.

The paucilamellar lipid vesicles of the present invention can be made by a variety of devices which provide sufficiently high shear for shear mixing. There are a large variety of these devices available on the market including a microfluidizer such as is made by Biotechnology Development Corporation, a “French”-type press, or some other device which provides a high enough shear force and the ability to handle heated, semi-viscous lipids. If a very high shear device is used, it can be possible to microemulsify powdered lipids, under pressure, at a temperature below their normal melting points and still form the lipid vesicles of the present invention.

An exemplary device which is useful for making lipid vesicles in accordance with the present invention has been developed by Micro Vesicular Systems, Inc. (Vineland, N.J.), and is further described in U.S. Pat. Nos. 4,895,452 and 5,013,497. Briefly, this device has a substantially cylindrical mixing chamber with at least one tangentially located inlet orifice. One or more orifices lead to a reservoir for the lipophilic phase, mixed with an oil phase if lipid-core PLVs are to be formed, and at least one of the other orifices is attached to a reservoir for the aqueous phase. The different phases are driven into the cylindrical chamber through pumps, e.g., positive displacement pumps, and intersect in such a manner as to form a turbulent flow within the chamber. The paucilamellar lipid vesicles form rapidly, e.g., less than 1 second, and are removed from the chamber through an axially located discharge orifice. In a preferred embodiment, there are four tangentially located inlet orifices and the lipid and aqueous phases are drawn from reservoirs, through positive displacement pumps, to alternating orifices. The fluid stream through the tangential orifices is guided in a spiral flow path from each inlet or injection orifice to the discharge orifice. The flow paths are controlled by the orientation or placement of the inlet or injection orifices so as to create a mixing zone by the intersection of the streams of liquid. The pump speeds, as well as the orifice and feed line diameters, are selected to achieve proper shear mixing for lipid vesicle formation. As noted, in most circumstances, turbulent flow is selected to provide adequate mixing.

Regardless of the device used to form the paucilamellar liposomes, if proper shear mixing is achieved, the resulting composition will include a foreign inclusion component, wherein at least a portion of the foreign inclusions are surrounded by a plurality of lipid bilayers, optionally having aqueous layers interspersed there between. Generally, a structure with about four lipid bilayers is standard, with a variation of about 2 to about 8 bilayers possible. The paucilamellar liposomes can range in diameter from about 2 nm to about 200 nm, depending upon the size of the foreign inclusion used.

The compositions which include a liposome as described herein are generally stable at acidic, neutral, alkaline, or basic pH. Thus, the compositions of the present invention are stable at pH of about 1, 2, 3, 4, 5, 6 . . . 14. In some embodiments, the composition is stable at a pH of between about 4 and about 12. A skilled artisan will know the appropriate pH for a particular use. Additionally, the pH of the composition can be altered or maintained using any method known in the art, e.g., addition of one or more suitable acids, bases or buffers.

Furthermore, the compositions which include a liposome as described herein are generally stable at room temperature. In certain cases, e.g., in plating baths, however, it can be desirable for the compositions to be stable at higher temperatures. Accordingly, the compositions of the present invention can be stable at temperatures greater than or equal to about 70° F., 80° F., 90° F., 100° F., 110° F. . . . 200° F. In some embodiments, the compositions are stable between about 140° F. and about 195° F. In other cases, it can be desirable for the compositions to be stable at temperatures lower than room temperature, i.e., lower than or equal to about 70° F., 60° F., 50° F., 40° F., 30° F., 20° F. . . . 0° F. All temperatures and ranges between the temperatures and ranges recited above are meant to be encompassed in the present invention.

Accordingly, in some embodiments, the liposomes include lipids and lipid vesicles which remain stable at high temperatures. This heat resistance is generally due in part to the presence of at least one high melting point component in the lipid bilayers of the liposome. Accordingly, the liposomes of the present invention can be used in the manufacture of products which are processed at high temperatures, e.g., in excess of 80° C. (176° F.). The lipid vesicles can be rendered heat stable by any method known in the art. For example, at least one ethoxylated alcohol having a long, substantially linear C₂₀-C₅₀ carbon chain can be incorporated into the bilayer. The long fatty carbon chain relative to the polar ethoxylated head group of this molecule gives it a high melting point compared to conventional surfactants used to prepare lipid vesicles. In some embodiments, soy sterol is used to provide increased stability to the lipids and lipid vesicles at higher temperatures.

Accordingly, in one embodiment, the present invention provides foreign inclusion liposomes which include a blend of non-ionic surfactants including a primary surfactant and at least one ethoxylated alcohol having a substantially linear C₂₀-C₅₀ carbon chain as described in U.S. Pat. No. 5,756,014. The lipid bilayers can further include a sterol which acts as a membrane modulator to regulate the shape and form of the lipid vesicles as well as their stability.

Other high melting point compounds (e.g., having a melting point of at least about 80° C. (176° F.)) can also be used in place of, or in addition to, the ethoxylated alcohol. For example, high melting point lipids, such as ceramides (e.g., phytoceramides) and other sphingolipids (e.g., N-oleoyl-phytosphingosine), can be used in the lipid bilayers of the vesicles to provide high temperature stability and additional moisture.

When used in preparations which are processed at high temperatures, lipid vesicles of the present invention can be made with ethoxylated alcohols which have a melting point which is greater than the highest temperature reached during processing of the preparation. Therefore, the lipid vesicles can be tailored for use in particular products according to the conditions of manufacture of the product. In general, the ethoxylated alcohol or other high melting point compound (e.g., phytoceramides), or combination thereof, is present as approximately 10-25% of the total lipid (by weight) of the vesicles. A variety of other liposome compositions, suitable for use in the processes described herein, are known and can be employed in the compositions and methods of the present invention.

To form the lipid vesicles of the present invention, the above-described lipid components can be blended at a sufficiently high temperature to form an even, homogenous lipid phase. This temperature will generally depend upon the melting point of the added high melting point compound. The lipid phase is then shear mixed with the aqueous phase under conditions sufficient to allow formation of the vesicles, as described above. This can also be achieved using other techniques known in the art, for example, as described in U.S. Pat. No. 5,163,809, entitled “Method and Apparatus for Producing Lipid Vesicles”, the disclosure of which is incorporated herein by reference.

Furthermore, a zeta potential modifying agent, e.g., a peptide, can be added to the composition. Generally, it can be advantageous to increase the overall zeta potential of a liposomal solution. Such an increase could, for example, reduce sedimentation in the liposomal solution. Exemplary peptides for use as zeta potential modifying agents include, but are not limited to heptalysine, acetyl heptalysine amide, acetyl heptalysine (acrylodan cysteine) amide, or analogs thereof. Alternatively, it can be desirable to reduce the overall zeta potential of the solution.

In certain embodiments, the compositions and methods of the present invention include or employ a foreign inclusion component. As used herein, the term “foreign inclusion” is used to refer to any material included in a plate that is not part of the metallic matrix that forms the plate. For example, foreign inclusions include materials added to metallic matrices in order to alter the properties of the matrix, e.g., the hardness of a plate on a tool.

Many foreign inclusions are known to the skilled artisan, all of which are encompassed by the present invention. The foreign inclusion can be, but is not limited to, diamond, diamond-like carbon, boron nitride, boron carbide, aluminum oxide, silicon carbide, tungsten carbide, titanium carbide, alumina, sapphire, zirconia, colorant, and/or mixtures thereof. In some embodiments, diamond or diamond-like carbon is used.

The term “diamond,” as used herein, refers to not only pure crystalline diamond but also to what is synthesized as a diamond film, i.e., embracing diamond-like carbon, graphite or amorphous carbon, or a mixture thereof. Such diamond can be sometimes called diamond-or-the-like or pseudo-diamond. The diamond can also include synthetic diamond, ultra disperse diamond, polycrystalline diamond, saw grit diamond, powdered diamond, monocrystalline diamond, and/or mixtures thereof. In specific embodiments, the diamond includes monocrystalline diamond. Such monocrystalline diamond can be advantageous because, e.g., it generally has a very uniform spherical structure and small (approximately 5 nm) diameter.

The diamond or diamond-like carbon can also be dispersed about another object, e.g., a metallic sphere or other metallic shape. Such a composition can be desired, e.g., to lower production costs in minimizing the use of the diamond.

The size of the foreign inclusions of the present invention can vary depending upon their intended use. The foreign inclusions can generally have a mean diameter of less than about 1 micron. For example, the mean diameter can be less than about 900 nm, 800 nm, 700 nm, 600 nm, 500 nm . . . 1 nm. Alternatively, the mean diameter of the foreign inclusion can be greater than about 1 μm, 2 μm, 3 μm, 4 μm, 5 μm . . . 10 μm. In some embodiments, the mean diameter is between about 200 nm and about 2 nm. All sizes and/or ranges between the sizes and/or ranges listed are also meant to be encompassed by the present invention. Including nano-sized particles in the compositions of the invention can be advantageous, e.g., in obtaining uniform encapsulation into liposomes, and uniform dispersion of the foreign inclusions or foreign inclusion liposomes into the metallic matrix.

The foreign inclusions of the present invention can be incorporated into the liposomes at a number of different concentrations. For example, the foreign inclusion may be incorporated into the liposomes at a concentration of about 0.5%, 1%, 2%, 3%, 4%, 5%, 6%, 7%, 8%, 9%, 10%, 12%, 14%, 16%, 18%, 20%, or more (by weight in comparison to the aqueous phase). All values and ranges between the listed values are meant to be encompassed in the present invention. Higher percentages are also encompassed by the present invention. In some embodiments, the foreign inclusion is incorporated in an amount such that no the foreign inclusion bodies occurs in the composition. For example, without wishing to be bound by any particular theory, it is believed that a paucilamellar liposome composition can contain about 18-20% diamonds by weight relative to the aqueous phase without significant aggregation of diamonds (e.g., aggregation outside the paucilamellar liposomes).

The addition of foreign inclusions into a metallic matrix is typically done to increase the hardness and/or wear resistance of the matrix. Alternatively, some foreign inclusions, e.g., TEFLON (PTFE), are included to provide greater lubricity than that which naturally occurs in the matrix.

In some embodiments, the foreign inclusions of the present invention include one or more colorants. As used herein, the term “colorant” refers to materials that impart the appearance of a color to a formulation. Colorants are meant to include both dyes as well as pigments.

A pigment is a solid substance, generally not water-soluble. Without wishing to be bound by any particular theory, it is believed that a pigment functions by absorbing some parts of the visible spectrum and reflecting others. Classes of pigments include, but are not limited to natural pigments, synthetic pigments, organic pigments and inorganic pigments.

Biological and organic pigments include, but are not limited to Heme/porphyrin-based pigments, such as chlorophyll, bilirubin, hemocyanin, hemoglobin, myoglobin; Light-emitting pigments, such as luciferin; Lipochromes, such as Carotenoids, alpha and beta carotene, anthocyanin, lycopene, rhodopsin, xanthophylls, canthaxanthin, zeaxanthin, lutein; Photosynthetic pigments, such as chlorophyll, phycobilin; Organic pigments, such as Pigment Red 170, phthalocyanine, Phthalo Green, Phthalo Blue, Alizarin, Alizarin Crimson, crimson, Indian Yellow, indigo, quinacridone, Quinacridone Magenta; Resins, such as gamboge; Polyene enolates; hematochrome; melanin; Phthalocyanine blue; urochrome; and Van Dyke brown.

Inorganic pigments include, but are not limited to Carbon pigments, such as bone black (also known as bone char), carbon black, ivory black, vine black, lamp black, Mars black, and charcoal; Cadmium pigments, such as Cadmium Green, Cadmium Red, Cadmium Yellow, and Cadmium Orange; Iron pigments, such as Caput Mortuum, Prussian blue, oxide red, red ochre, Sanguine, and Venetian red; Iron oxide pigments, such as terra verte, Verona Green, Mars Red, and Mars Yellow; Chromium pigments, such as Chrome Green and chrome yellow; Cobalt pigments, such as cobalt blue and cerulean blue; Lead pigments, such as lead white, Naples yellow, Cremnitz White, Foundation White, and red lead; Copper pigments, such as Paris Green and verdigris; Niobium pigments; Titanium pigments, such as titanium dioxide and titanium white; Sulfur pigments, such as ultramarine, Ultramarine Green Shade, French Ultramarine, and vermilion; Chrome pigments, such as viridian; Zinc pigments, such as zinc white; clay earth pigments, such as sienna, raw sienna, burnt sienna, umber, raw umber, burnt umber, and yellow ochre; limonites; hematites; manganese oxides and manganese ores.

A dye is a colored substance and is often water soluble, unlike a pigment. Dyes generally have an affinity for a specific substrate, and thus can be complexed with one or more metallic salts, which then render the dye insoluble.

The dyes of the present invention may be obtained from natural sources, e.g., animal, vegetable (for example, roots, berries, bark, leaves and wood) or mineral sources, with no or very little processing. Dyes may also be synthetic in origin.

Classes of dyes include, but are not limited to, natural dyes, inorganic dyes, food dyes, acid dyes, basic dyes, mordant dyes, vat dyes, reactive dyes, disperse dyes, oxidation bases, sulfur dyes, leather dyes, fluorescent brighteners, solvent dyes, and carbene dyes.

Exemplary dyes include, but arc not limited to acridine dyes, anthraquinone dyes, arylmethane dyes, diaryl methane dyes, triarylmethane dyes, azo dyes, cyanine dyes, diazonium dyes, nitro dyes, nitroso dyes, phthalocyanine dyes, quinone-imine dyes, azin dyes, eurhodin dyes, safranin dyes, indamins, indophenols, oxazin dyes, oxazone dyes, thiazin dyes, thiazole dyes, xanthene dyes, fluorene dyes, pyronin dyes, rhodamine dyes, fluorone dyes, eosin, iron buff, tyrian purple, kermes, cochineal, techelet, walnut hulls, safflower, turmeric, indigo, woad, alizarin (madder), dyer's broom, brazilwood, quercitron bark, weld, old fustic, and cudbear.

As used in paints, colorant is placed in a liquid, which is applied to a surface. When the liquid dries into a film, the colorant is then stuck to the surface. The present invention is based, at least in part, on the realization that a colorant can be employed as a foreign inclusion component to impart a surface effect to a plate. Such surface effects can include a surface coloration effect and/or a surface finish effect. For example, titanium dioxide liposomes may be able to impart a white color or tint to a plate. In some embodiments, the color is stark, e.g., where the foreign inclusion is incorporated into the plate close to the surface and/or where the liposome is no longer disposed about the foreign inclusion. In other embodiments, color can be more of a light hue or tint, e.g., where the foreign inclusion is incorporated into the plate further from the surface and/or where the liposome remains at least partially disposed about the foreign inclusion. Surface finish effects include, but are not limited to a flat surface finish, a matte surface finish, a semi-gloss surface finish, a gloss surface finish, a bumpy or striated surface finish, or any combination or gradation of the same.

Without wishing to be bound by any particular theory, it is believed that imparting of such a surface effect can reduce oxidation of a metallic structure, thus increasing the lifetime of the article and reducing or eliminating the need to treat the surface, e.g., by painting. For example, materials used in large permanent or semi-permanent structures, e.g., Zinc-coated I-beams used to build bridges, can oxidize. Such structures, therefore, are generally painted to retain an aesthetically pleasing surface. Painting such large structures can be time consuming and costly. Use of a colorant in plating the surfaces of materials used to build such structures can impart a color to the structure as described above. Plating with a colorant as described herein may therefore reduce the need for painting large structures, thus lowering the cost of upkeep.

In some embodiments, colorants, e.g., dyes and pigments, as used in the present invention are insoluble in water. This may be advantageous because they will remain in the plate even if the liposome does not get plated. In other embodiments, the colorants are moderately or fully soluble in water.

The colorant used as foreign inclusions may have any particle size in accordance with the present invention. In some embodiments, the particle size of the dye is less than about 200 nm. In other embodiments, the particle size of the dye is less then or equal to about 50 nm. In some embodiments, the particle size is less then or equal to about 20 nm. In some embodiments, the colorant is titanium dioxide.

Colorants of the present invention can also provide color stability to plated objects. That is, an object plated with a composition including a colorant of the present invention can maintain substantially the same coloration for at least 6 months, at least 1 year, at least 2 years, at least 3 years, at least 5 years, at least 10 years, at least 15 years, at least 20 years, or more. Without wishing to be bound by any particular theory, it is believed that the length of time a surface effect lasts will depend, at least in part, on the thickness of the plate including the colorant. For example a 5 mil thick plate including a colorant will likely retain its surface effect longer than a 1 mil thick plate including a colorant. One reason for this is that as the plate is worn away over time, the surface effect will be replenished by exposing colorant embedded in the plate.

In certain embodiments of the present invention, the foreign inclusions and/or foreign inclusion liposomes as described above are at least partially disposed within a metallic matrix, e.g., a plate. As such, in another aspect, the present invention provides a composition including a plurality of foreign inclusions and/or foreign inclusion liposomes at least partially disposed within a metallic matrix.

The liposomes can be any of the liposomes as described above, e.g., paucilamellar liposomes, unilamellar liposomes, multilamellar liposomes, and/or liposomes with a high melting point component added. The foreign inclusions can also be any of those described herein, e.g., foreign inclusions with a mean diameter of less than about 1 micron. The metallic matrix can include any metal. Generally, metallic matrices of the present invention utilize metals that can be plated by electrolytic or electroless plating methods, i.e., the compositions can be plating. Exemplary metals include, but are not limited to, boron nickel, chromium, nickel, copper, palladium, gold, silver, zinc, tin, cobalt, aluminum, and combinations, or alloys, thereof.

In some embodiments, the dispersion of the foreign inclusions or foreign inclusion liposomes in the metallic matrix is substantially uniform. Such uniformity in a metallic matrix can be advantageous because, e.g., it can increase the hardness or wear resistance of the object on which it is plated. The term “substantially uniform,” as used herein, generally denotes that the variation of the thickness of the metallic matrix, including the foreign inclusions and/or foreign inclusion liposomes, throughout the area where, e.g., plating occurs, will be less than or equal to about ±5%, about ±4%, about ±3%, about ±2%, about ±1%, or even about ±0.5%. In some embodiments, the level of homogenization of foreign inclusions or foreign inclusion liposomes in the metallic matrix is about 10 counts/μm³, 50 counts/μm³, 100 counts/μm³, 500 counts/μm³, 1000 counts/μm³, 5000 counts/μm³ . . . 50,000 counts/μm³. Generally, the level of homogenization of foreign inclusions or foreign inclusion liposomes in the metallic matrix can be between about 100 counts/μm³ and about 10,000 counts/μm³. All values and ranges between these values and ranges are meant to be encompassed in the present invention. Factors influencing the levels of homogenization can include the method of loading, the amount of foreign inclusions or foreign inclusion liposomes loaded, and/or the size of the loaded particles.

In some embodiments, the plate obtained employing the methods and compositions of the present invention exhibits improved hardness as compared to plate obtained using conventional methods. The hardness can be increased compared to a metallic matrix with no foreign inclusions or foreign inclusion liposomes, or can be increased compared to a metallic matrix with a different, e.g., lower, load of foreign inclusions or foreign inclusion liposomes. The hardness of diamonds embedded in boron nickel is about 2000 knoop. In some embodiments, the hardness of the compositions is greater than or equal to about 2000 knoop, 2500 knoop, 3000 knoop, 3500 knoop . . . 5000 knoop. All values between these values are meant to be encompassed by the present invention. It is believed that improved hardness can be achieved because the compositions of the invention facilitate and achieve a more uniform dispersion of foreign inclusions in the plate. In some embodiments, improved hardness is achieved at a lower concentration of inclusions, thus providing a significant economic benefit.

Additionally or alternatively, the plate of the present invention can exhibit increased or reduction of friction in use as compared to conventional compositions. In these embodiments, the lipid and other components of the liposomes, entrapped in the matrix, act as a lubricant. Accordingly, in some aspects, the present invention is directed to a composition which includes a metallic matrix, a foreign inclusion or a foreign inclusion liposome, and a lubricant. The lubricant can be or include the liposomes or any component of the liposomes, e.g., lipid. Additionally or alternatively, the composition can include additional lubricants, e.g., PTFE.

In some aspects, the present invention is directed to a plated article of manufacture for industrial processes or for building processes comprising an article of manufacture and any of the compositions described herein. That is, the liposomes of the present invention can be used to include foreign inclusions or foreign inclusion liposomes in a plate that is disposed about, for example, a saw tool, a drill bit, a cutting tool, a grinding tool, and/or an abrasive tool. Additionally or alternatively, foreign inclusions or foreign inclusion liposomes can be included in a plate that is disposed about, for example, a screw, a bolt, a nut, a pipe, a beam, an I-beam, and/or a metal cable.

Any industrial plating process, e.g., any method of plating, electrolytic or electroless, as described herein or as known to a skilled artisan, can be modified to include a foreign inclusion. Accordingly, the compositions and methods of the present invention can be employed where any conventional plating process is used. Furthermore, the plating methods and compositions can be used to plate any item that can be plated by such methods. Plating can be used to change the properties of an object (e.g., wear resistance) or solely for appearance (e.g., plating flatware or jewelry).

Accordingly, in yet another aspect, the present invention also provides a method for plating using the compositions described herein. The method generally includes providing a plurality of foreign inclusion liposomes comprising a liposome component and a foreign inclusion component in a plating apparatus, and plating with a metal such that at least a portion of the foreign inclusion components are at least partially disposed in a metallic matrix. The plating apparatus can be, e.g., an electroless plating bath or an electrolytic plating bath.

In some embodiments, the plating methods of the present invention include the addition of extra foreign inclusion liposomes to the bath. Such addition can be done, for example, when some or all of the foreign inclusion liposomes originally present in the bath have been already plated. That is, the plating bath does not necessarily need to be refreshed in between individual plating processes. If the concentration of foreign inclusion liposomes drops below a desired level, additional foreign inclusion liposomes can be added without replacing the entire bath. Additional foreign inclusion liposomes can be added to a plating bath in a formulation having the same foreign inclusion concentration as the original bath, or in a formulation having a higher foreign inclusion concentration. For example, the original bath may contain 4% by weight diamonds (as compared to the aqueous phase), and, if needed, an added formulation can be 4%, 8%, 12% by weight diamonds, or more.

The methods of the invention can further include heat treatment. Heat treatment is generally used to improve adhesion or to modify properties of a plate. As a result of heat treatment, hardness, corrosion resistance, wear resistance, ductility and stress, fatigue properties, magnetic properties, and other qualities of the deposit can be manipulated. In some embodiments, heat treatment is performed employing temperatures from about 200° F. to about 750° F. (about 93° C. to about 400° C.) for 30 minutes to several hours. In some embodiments, maximum hardness is produced by heating at about 750° F. (400° C.), followed by cooling slowly to 390° F. (200° C.) or lower. Extreme heat treatment can change physical, mechanical and protective properties. In some embodiments, heat treating is carried out in an inert atmosphere such as one of argon or nitrogen, in order to minimize oxidation.

In some embodiments, the plate has a substantially uniform thickness as described previously. Additionally or alternatively, as described herein, the dispersion of foreign inclusions or foreign inclusion liposomes in the metallic matrix can also be substantially uniform. In other embodiments, the method of the present invention can produce a plate with non-uniform thickness and or with a dispersion of foreign inclusions or foreign inclusion liposomes that is not uniform.

In some embodiments, the plating apparatus includes a bath with a suspension of foreign inclusion liposomes. The foreign inclusion can be any of the foreign inclusions described herein, including, but not limited to diamond, diamond-like carbon, boron nitride, boron carbide, aluminum oxide, silicon carbide, tungsten carbide, titanium carbide, alumina, sapphire, zirconia, colorant, and mixtures thereof.

The metallic matrix created in the plating bath can include, but is not limited to, boron nickel, chromium, nickel, copper, palladium, gold, silver, zinc, tin, cobalt, aluminum, and/or combinations thereof. That is, the plating bath can include any known ions of, e.g., boron, chromium, nickel, copper, palladium, gold, silver, zinc, tin, cobalt, aluminum and any combinations thereof. The plating bath can include other metals which are used in electrolytic or electroless plating. Furthermore, the plating bath can include any other materials that are commonly used in plating baths. Thus, the plating bath can include, e.g., counter ions from the metal salts, buffers, chelators, electrolytes, electrodes, reducing agents, and/or catalysts.

The method can include submerging, e.g., a saw tool, a drill bit, a cutting tool, a grinding tool, an abrasive tool, a screw, a bolt, a nut, a pipe, a beam, an I-beam, and/or a metal cable, or any portion of such object, into the plating bath in order to plate a metallic matrix onto the surface of the object.

Furthermore, the plating can occur at a variety of pH and temperature ranges, including those typically used in plating. Accordingly, the plating bath can have acidic, neutral, alkaline, or basic pH, e.g., at pH of about 1, 2, 3, 4, 5, 6 . . . 14. In some embodiments, the pH of the plating bath is between about 4 and about 12. The plating bath can also be maintained at varying temperatures, e.g., greater than or equal to about 70° F., 80° F., 90° F., 100° F., 110° F. . . . 200° F. or lower than or equal to about 70° F., 60° F., 50° F., 40° F., 30° F., 20° F. . . . 0° F. In certain embodiments, the plating bath is maintained at between about 140° F. and about 195° F.

The plating step or steps can be repeated one or more times, e.g., in order to add more than one plate to a single surface. Generally, one or more of size, type, quality, and/or concentration, of foreign inclusions or foreign inclusion liposomes can be varied during the one or more times the method is repeated. In other embodiments, the same or similar size, type, quality, and concentration of foreign inclusions or foreign inclusion liposomes are used in each of the repeated methods.

Occasionally, a plating bath can lose its functionality due to impurities, e.g., oxygen, in the solution. In some embodiments, therefore, the effective life of the plating bath is lengthened by the addition of an antioxidant or by providing one or more inert gasses to the plating bath in order to remove dissolved oxygen.

In some embodiments, wet plating is employed in accordance with the methods of the present invention. Wet plating methods for reducing metal ions in a bath and depositing the ions onto the surface of an object to be plated can be classified roughly into electroplating (electrolyzing deposition) and electroless plating (chemical deposition) on the basis of the reduction mechanism as generally known. Accordingly, the present invention is directed to a plating composition which includes foreign inclusion liposomes. The plating composition can be a plating bath, which can be electrolytic or electroless.

For example, in some embodiments, the liposomes of the present invention are included in an electrolytic plating bath. That is, in certain aspects of the present invention, the foreign inclusions and/or foreign inclusion liposomes are trapped within a metallic matrix using an electrolytic process. Methods for the electrolytic deposition of metals are widely known and used in industry to deposit metals. Deposits of various metals and alloys are extensively used in a wide variety of functional and decorative applications. Typical metals used in electrolytic plating include, but are not limited to, zinc, copper, cadmium, chromium, nickel, cobalt, gold, silver, palladium, platinum, ruthenium, and alloys of these metals with each other and with tin and lead. Additional additives may also be used in electroless plating baths, e.g., to brighten the deposit and/or increase the hardness.

Electrolytic plating utilizes an electrical current to deposit a metal onto the surface of an object. Generally, the reaction that occurs in an electrolytic plating bath is: M⁺⁺+2e⁻→M°.

One advantage of electroplating is the maintenance of a roughly constant composition in the plating bath which, during plating, provides metal ions from the anode in basically the same amount as the amount being deposited on the surface of the object to be plated. This allows the plating bath to be continuously used for an extended period of time. However, in electroplating, the object to be plated is generally limited to objects whose surfaces are electrically conductive, and depending on the form of the object to be plated, the thickness of the plated layer can become uneven. Problems with thickness, however, can sometimes be overcome, e.g., by the use of an eductor, which may help prevent formation of stagnant zone(s) within a plating apparatus, or by reverse pulse plating, which generally increases metal deposit quality and leveling, particularly at higher average current densities.

Commercially, electrolytic plating allows rapid plating while still maintaining good quality deposits for the particular application at hand. Smooth deposits are particularly important because it yields good surface electrical contacts and insures low porosity for the plating thickness attained.

In other embodiments, the liposomes of the present invention are included in an electroless plating bath. That is, in certain aspects of the present invention, the foreign inclusions or foreign inclusion liposomes are trapped within a metallic matrix using an electroless process. Methods for the electroless deposition of metals are also widely known and used in industry to deposit a variety of metals, including nickel, onto various substrates. The substrate can be, but is not limited to, stainless steel, aluminum, or a nonconductive surface. The plating metal can be, but is not limited to, boron nickel, chromium, nickel, copper, palladium, gold, silver, zinc, tin, cobalt, aluminum, and combinations thereof.

Electroless plating, e.g., electroless nickel (EN) plating, does not require rectifiers, electrical current or anodes, unlike most electrolytic processes. In general, electroless deposition compositions contain a salt of the metal to be deposited, a reducing agent capable of reducing metal ions to the metal in the presence of a catalytic surface, a chelating agent to maintain the metal in solution, and a pH-adjusting agent. Other substances such as stabilizers, brighteners, surfactants and other similar additives can also be present. Deposition of a metallic matrix on an object occurs because of one or more chemical reactions on the surface of the object.

Generally, the reaction that occurs in an electroless plating bath is: M⁺⁺+RA+H₂O→M°+RA*+2H⁺, where RA is a chemical reducing agent, and RA* is a chemical reducing agent that has been oxidized. As used herein, the term “reducing agent” refers to any substance capable of bringing about a reduction in another substance. This is normally achieved by oxidation of the reducing agent. For purposes of the present invention, any reducing agent can be chosen, and is generally chosen based upon the metal being reduced. An exemplary electroless plating bath can be found in U.S. Pat. No. 4,600,609, the contents of which are incorporated herein by reference.

The deposition of a metallic matrix onto a surface by electroless plating is auto-catalytic. That is, once a single layer has formed on the surface, it becomes the catalyst for the next layer. Accordingly, the resulting plate can be very thick, if desired, provided that the other materials in the plating bath are still functioning, or periodically replenished. Furthermore, the thickness of the metallic matrix on the surface is at least substantially uniform because every surface immersed in the plating bath is plated. Uniformity of thickness is difficult to achieve by any other method, especially, e.g., where the surface to be plated has an irregular geometry.

In some embodiments, the thicknesses of the plate can range from about 0.1 mil to about 30 mils. In other embodiments, the thickness of the plate can range from about 0.1 mils to about 5 mils.

In general, different types of electroless plating baths provide different properties. A person of ordinary skill in the art would be able to determine the type of electroless plating bath needed for a specific purpose using no more than routine experimentation. For example alkaline nickel-phosphorus baths plate at relatively low temperatures, making them suitable for plating on plastics, nickel-boron baths are sometimes used in industrial wear applications because of their high hardness levels, and certain electroless plating solutions produce deposits having three or four elements, e.g., nickel-cobalt-phosphorus, nickel-iron-phosphorus, nickel-tungsten-phosphorus, nickel-rhenium-phosphorus, nickel-cobalt-phosphorus, nickel-molybdenum-boron, nickel-tungsten-boron, and others.

In certain embodiments, an electroless nickel (EN) process is used in the present invention. The properties of EN have made it very useful in a broad range of functional applications which take advantage of these properties. For example, EN has excellent corrosion resistance, low density as compared to pure metallurgical nickel, lower coefficient of thermal expansion as compared to values for electrodeposited nickel, low heat of conductivity compared to pure metallurgical nickel, a wide range of melting temperatures depending upon the amount of, e.g., phosphorus alloyed in the deposit. Furthermore, EN is essentially nonmagnetic as plated, it has high electrical resistivity compared to pure metallurgical nickel, it is easily soldered, excellent adhesion of EN deposits can be achieved on a wide range of substrates, a wide range of coating thicknesses can be obtained, often with uniformity and minimum variation, and brightness and reflectivity of electroless nickel vary significantly, depending on the specific formulation.

In some embodiments, plates made in accordance with the present invention exhibit improved properties. There are a number of specifications and test methods commonly used to judge the quality of plated material. The physical properties normally of interest include, but are not limited to, hardness, thickness, porosity, corrosion resistance, and solderability. Many of these tests have been developed by, and are readily available from, the American Society for Testing and Materials (ASTM).

For example, hardness can be determined using ASTM B-578 “Microhardness of Electroplated Coatings.” Generally a 100-gram load and a deposit thickness of two mils unless otherwise specified. In another example, the thickness of deposits can be determined by examining a cross-section microscopically, by beta backscatter methods, by x-ray fluorescence, or by using a micrometer before and after processing the article or a test specimen. In general, plated parts can be inspected for pits and porosity by a number of methods well known in the art, e.g., a ferroxyl test, a copper sulfate test, an alizarin test, a hydrochloric spot test, a five percent neutral salt spray test, or an electrochemical pitting test. Many corrosion test methods are also known to determine the corrosion rate of 1 deposit in various environments, including an immersion weight loss test and sn electrochemical test. Finally, solderability tests can be performed by heating a plated article to 450° F. (232° C.) and applying a 60-40 tin-lead solder. If the solder wets the surface, the deposit is solderable.

### EXEMPLIFICATION

### Example 1

### Preparation of Paucilamellar Diamond Liposomes

Glyceryl monosterate (about 9% by weight of initial composition), PEG-100 stearate (about 1% by weight of initial composition), polysorbate 80 (about 2% by weight of initial composition), glyceryl dilaurate (about 2% by weight of initial composition), cetyl alcohol (about 1% by weight of initial composition), Soybean sterol (about 1% by weight of initial composition) was mixed with mineral oil and preservatives. 100-150 g of this initial composition was combined with monocrystalline diamonds (approximately 20 grams, 4% by weight relative to the aqueous phase) to form a mixture. This mixture was then blended with about 500 mL water under shear mixing conditions, to form paucilamellar lipid vesicles.

Additional formulations were also made as described above using 250 ml or 167 ml of water (8 and 12% by weight diamonds relative to the aqueous phase, respectively) to increase the number of paucilamellar liposomes containing diamonds and to reduce the number of paucilamellar liposomes containing only the aqueous phase.

### Example 2

### Paucilamellar Diamond Liposomes as Polishing Formulations

A formulation of paucilamellar diamond liposomes as formulated in Example 1 was observed visually after 4 months. The formulation shows that no diamonds and/or diamond liposomes had dropped out of solution, and there appeared to be no diamond aggregation. Additionally, there appeared to be little or no concentration gradient present in the solution.

Such formulation will be used to polish a hard surface, e.g., a plated drill bit. It is expected that the formulation of the present invention will provide a polished surface equal to or superior to a surface polished with diamonds alone in a polishing formulation (i.e., a formulation including diamonds not partially disposed within liposomes).

### Example 3

### Electrolytic Plating with Paucilamellar Diamond Liposomes

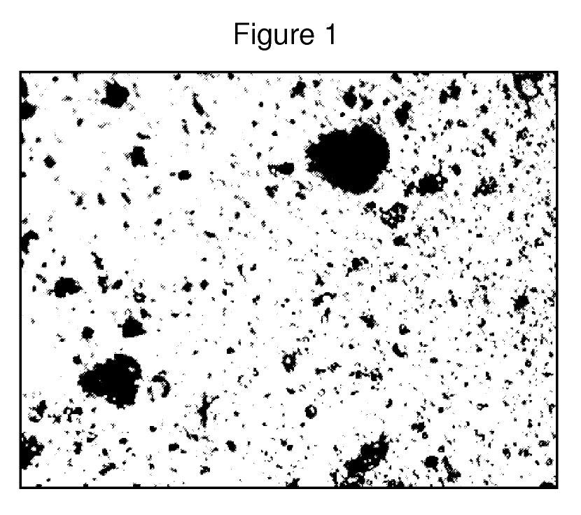

5-15 g of a formulation of paucilamellar diamond liposomes as formulated in Example 1 was added to an electrolytic nickel plating bath. The electrolytic nickel plating bath included nickel sulfamate (a source of nickel ions), boric acid, (a buffer), and nickel bromide. A steel plate was at least partially immersed in the bath, and 10-30 ASF of current was applied to the bath (heavier deposits are achieved at higher current densities) at 100-120° F., producing a plate on the immersed steel plate. A microscopic image of the resultant plate is shown in FIG. 1. As can be seen by the small circles, diamonds and/or diamond liposomes have been incorporated into the plate.

### Example 4

### Electroless Nickel Plating with Paucilamellar Diamond Liposomes

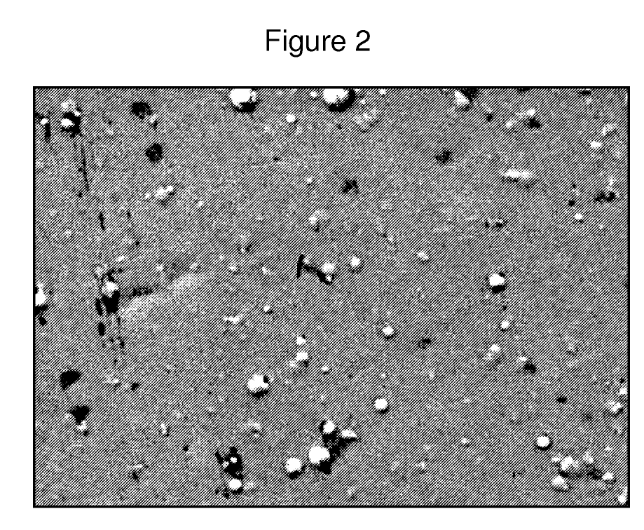

5-15 g of a formulation of paucilamellar diamond liposomes as formulated in Example 1 was added to an electroless nickel plating bath. The electroless nickel plating bath included sodium hypophosphite (a reducing agent), nickel sulfate (a source of nickel ions), and organic acids used as buffers and complexors. A steel plate was at least partially immersed in the bath at between 150-160° F. and at a pH of 5.0-5.5, producing a plate on the immersed steel plate. A microscopic image of the resultant plate is shown in FIG. 2. As can be seen by the small circles, diamonds and/or diamond liposomes have been incorporated into the plate, however not to the same extent as the electrolytic process. It is believed, however, that under the correct conditions, a higher concentration of diamonds will be incorporated into the plate formed using the electroless process.

### EQUIVALENTS

Those skilled in the art will recognize, or be able to ascertain using no more than routine experimentation, many equivalents to the specific embodiments of the invention described herein. Such equivalents are intended to be encompassed by the following claims.

Additionally, all references, including articles and patent publications, are explicitly incorporated herein by this reference.

1-26. (canceled)

27. A composition comprising a plurality of foreign inclusion liposomes at least partially disposed within a metallic matrix.

28. The composition of claim 27, wherein the liposomes are paucilamellar liposomes.

29. The composition of claim 27, wherein the composition is plating.

30-32. (canceled)

33. A composition comprising a plurality of foreign inclusion particles at least partially disposed within a metallic matrix, wherein the dispersion of the foreign inclusion particles in the metallic matrix is substantially uniform.

34. The composition of claim 33, wherein the level of homogenization of foreign inclusion particles in the metallic matrix is between about 100 counts/μm³ and about 10,000 counts/μm³.

35. The composition of claim 33, wherein the hardness is above about 2500 knoop.

36. The composition of claim 33, wherein the metallic matrix comprises at least one metal from the group consisting of: boron nickel, chromium, nickel, copper, palladium, gold, silver, zinc, tin, cobalt, aluminum, and combinations thereof.

37. The composition of claim 33, wherein the composition is plating.

38. The composition of claim 37, wherein the plating is disposed about at least one member selected from the group consisting of: a saw tool, a drill bit, a cutting tool, a grinding tool, an abrasive tool, a screw, a bolt, a nut, a pipe, a beam, an I-beam, and a metal cable.

39. The composition of claim 33, wherein the foreign inclusion comprises at least one member selected from the group consisting of: diamond, diamond-like carbon, boron nitride, boron carbide, aluminum oxide, silicon carbide, tungsten carbide, titanium carbide, alumina, sapphire, zirconia, colorant, and mixtures thereof.

40-44. (canceled)

45. The composition of claim 33, wherein the foreign inclusion component comprises a colorant.

46-47. (canceled)

48. The composition of claim 33, wherein the foreign inclusion component comprises foreign inclusion particles having a mean diameter of less than about 1 micron.

49. The composition of claim 33, wherein the foreign inclusion component comprises foreign inclusion particles having a diameter between about 2 nm and about 200 nm.

50. A plated article of manufacture for industrial processes or building processes comprising
an article of manufacture for industrial processes or building processes; and
a composition of claim 33 at least partially disposed about the article.

51-53. (canceled)

54. A method for plating, the method comprising:
(a) providing a plurality of foreign inclusion liposomes comprising a liposome component and a foreign inclusion component in a plating apparatus; and
(b) plating with a metal such that at least a portion of the foreign inclusion components are at least partially disposed in a metallic matrix.

55. The method of claim 54, wherein the plating apparatus is an electroless plating bath or an electrolytic plating bath.

56. The method of claim 54, further comprising heat treating the plating.

57. The method of claim 54, wherein the metallic matrix is plated in a substantially uniform thickness.

58. The method of claim 54, wherein the dispersion of the foreign inclusion component in the metallic matrix is substantially uniform.

59-74. (canceled)

75. The method of claim 54, which is repeated one or more times.

76-79. (canceled)
